(19) United States
(12) Patent Application Publication
(10) Pub. No.: US 2015/0331196 A1
(43) Pub. Date: Nov. 19, 2015

(54) SMART AR COATED GRIN LENS DESIGN COLLIMATOR

(71) Applicant: Advanced Fiber Products, LLC, Des Plaines, IL (US)

(72) Inventor: Igor G. Stouklov, Walnut, CA (US)

(73) Assignee: Advanced Fiber Products, LLC, Des Plaines, IL (US)

(21) Appl. No.: 14/711,748

(22) Filed: May 13, 2015

Related U.S. Application Data
(60) Provisional application No. 61/992,836, filed on May 13, 2014.

(51) Int. Cl. G02B 6/32; G02B 3/00; G02B 1/11

(52) U.S. Cl. CPC G02B 6/32; G02B 1/11; G02B 3/0087

(57) ABSTRACT

Anti-reflective (AR) coating on the back side of the GRIN lens with a specific coating performance to match the index of refraction of fiber glass, such as 1.47, and then to select an index matching resin to join the components with the same index of refraction as the rear AR coated lens and fiber in the ferrule, such as 1.47 again, thus to provide virtually lossless cavity, where n₁, n₂ and n_{g} are all the same, so reflective loss (RL) is almost infinite and no Fabry Perot effects are observed.

### CROSS-REFERENCE TO RELATED APPLICATIONS

This patent application claims priority to provisional patent application entitled “Smart AR Coated GRIN Lens Design Collimator” filed on May 13, 2014, having Ser. No. 61/992,836, which is hereby incorporated by reference.

### BACKGROUND OF THE INVENTION

1. Field of the Invention

The present invention relates generally optical fibers, and more particularly to gradient-index (GRIN) optics.

2. Description of Related Art

Instead of using a ball lens, a gradient index lens can be used as a coupling element in fiber optics. A gradient-index (GRIN) lens has a gradient profile in which the refractive index varies in the direction perpendicular to the optical axis, as expressed in the following equation:

N=N₀[1−(k/2)r²]

where N₀ is the base index (at the center of the lens), k is called the gradient constant, and r is the variable radius (mm). The operation of a gradient index (GRIN) lens can be explained by considering a conventional lens. In a conventional curved lens, an incoming light ray is first refracted when it enters the curved lens surface because of the abrupt change of the refractive index from air to the homogeneous material of the curved lens. The light ray passes through the lens material in a direct way until it emerges through the exit surface of the curved lens where the light ray is refracted again because of the abrupt index change from the lens material to air. A well-defined surface shape of the curved lens causes the light rays to be focussed on a spot and to create the image. A high precision is required for the fabrication of the surfaces of conventional curved lenses, which can complicate the miniaturization process of lenses and raises the costs of production. (See FIGS. 7a and 7b).

GRIN (Graded Index Lens) lenses represent an alternative to conventional lenses since the lens performance depends on a continuous change of the refractive index within the lens material. Instead of complicated shaped surfaces, plane optical surfaces are used in GRIN lenses. Light rays are continuously bent within the GRIN lens until they are focussed on a spot. Miniaturized lenses convenationally are fabricated down to 0.2 mm in thickness or diameter. Changing the lens length causes the image plane to lie directly on the surface plane of GRIN the lens so that sources such as optical fibers can be glued directly onto the GRIN lens surface to couple light into the lens.

The most commonly used optical collimators for Telecommunications devices consist of 4 main components: (1) fiber, usually single mode or PM (Polarization Maintaining), (2) ferrule/capillary for holding the fiber, (3) GRIN Lens, (Graded Refractive Index) Lens, and (4) index matching resin to bond the fiber or fiber older to the lens. These four components are used for producing collimated light beams of a target diameter and a controlled working distance (WD). Typical parameters of performance measured include Insertion Loss, Return Loss (RL), working distance (WD), Beam Diameter (defined typically at an exit of the collimator and the same WD) and Beam Diameter at the beam waist (1/2 WD positions).

Traditionally, collimators are produced using angle polished (AP) components for higher return loss performance (lower reflected power), usually with single mode fibers. This is difficult to do for small diameter components with single mode fiber and especially difficult for those using polarization maintaining fibers which then also would require visual rotational alignment of fiber stress rods to control the fast and slow axes of the polarized beams. Hence, in the case of polarization maintaining fibers, the use of flat polished physical contact (PC) and coupled components have historically been the only solution to the detriment of return loss performance as per the design shown in FIGS. 7a, 7b, 8a, 8b, and 9.

In summary, main disadvantage of PC design is low return loss caused by mismatch between index of refraction of an optical fiber (typical n18 1.47) and a GRIN lens (typical around n˜1.6). It is known that any optical interface with different indices of refraction n₁ and n₂ creates reflection of part of the light power, defined by Fresnel equations set for below:

The reflectance for s-polarized light is:

$${R}_{s} = {\vert \frac{{n}_{1} cos {θ}_{i} - {n}_{2} cos {θ}_{t}}{{n}_{1} cos {θ}_{i} + {n}_{2} cos {θ}_{t}} \vert}^{2} = {\vert \frac{{n}_{1} cos {θ}_{i} - {n}_{2} \sqrt{1 - {( \frac{{n}_{1}}{{n}_{2}} sin {θ}_{i} )}^{2}}}{{n}_{1} cos {θ}_{i} + {n}_{2} \sqrt{1 - {( \frac{{n}_{1}}{{n}_{2}} sin {θ}_{i} )}^{2}}} \vert}^{2} ,$$

while the reflectance for p-polarized light is:

$${R}_{p} = {\vert \frac{{n}_{1} cos {θ}_{t} - {n}_{2} cos {θ}_{i}}{{n}_{1} cos {θ}_{t} + {n}_{2} cos {θ}_{i}} \vert}^{2} = {\vert \frac{{n}_{1} \sqrt{1 - {( \frac{{n}_{1}}{{n}_{2}} sin {θ}_{i} )}^{2}} - {n}_{2} cos {θ}_{i}}{{n}_{1} \sqrt{1 - {( \frac{{n}_{1}}{{n}_{2}} sin {θ}_{i} )}^{2}} + {n}_{2} cos {θ}_{i}} \vert}^{2}$$

In case of the PC collimator, light propagates perpendicular to all surfaces, so the power reflectance for all polarizations is

R=Pᵣ/Pᵢ=(n₁−n₂)^{2/(}n₁+n₂)²

Optical return loss, measured in dB, is defined as:

$$RL ( dB ) = 10 {log}_{10} \frac{{P}_{i}}{{P}_{r}}$$

where RL(dB) is the return loss in dB, Pᵢ is the incident power and Pᵣ is the reflected power. For example, with a typical fiber glass/air interface, R˜4% and RL˜14 dB.

Another problem is caused by the cavity between the fiber and back of the lens created by a Fabry Perot resonance effect due to interference of light beams reflected back and forth between two parallel surfaces. This leads to wavelength dependence effects on optical properties of the collimator, for example, sinusoidal non-uniform reflectivity over wavelengths with a period of Δλ=λ^{2/n}_{g}L, where λ—is a center wavelength, n_{g}—resin index of refraction, L—cavity thickness.

Typically one uses index matching resin/glue in between the ferrule and the lens to minimize the back reflection. Unfortunately, even for the perfect resin with index of refraction in the middle between typical glass n=1.47 and GRIN lens n=1.6 would give unsatisfactory return loss performance for modern Telecoms applications.

Usually, the front side of the lens is AR (anti reflection) coated to greatly reduce back reflection from the lens/air interface, but the back side of the lens is left uncoated.

Accordingly, there is a need for a collimator having minimal light reflection at the air glass interface and maximize optical transmission efficiency throughout its construction.

### ASPECTS AND SUMMARY OF THE PRESENT INVENTION

One aspect of the present invention is to provide a collimator having minimal light reflection at the air glass interface and maximize optical transmission efficiency.

Another aspect of the present invention is to match the reflective index (RI) of the a GRIN lens back-face, resin, and an optical fiber at the back of the GRIN lens, and wherein the GRIN lens is mounted in a cylindrical tube which is bonded with the resin to the a ferrule holding the optical fiber in a capillary.

Another aspect of the present invention is to provide a fiber pigtailed GRIN (Graded Index Lens) assembly, constructed of a GRIN lens with a AR coating on a back-face of the GRIN lens having a specific optical coating performance to match the index of refraction of the glass fiber (typically 1.47), a index matching resin to join and adequately fix the components with the same index of refraction as the rear AR coating on the lens and the glass fiber which is mounted in a ferrule, providing virtually lossless lens, glue/resin, fiber interface cavity, where n₁, n₂ and n_{g} are all common so the reflected power at the cavity is minimized and the forward transmission power is maximized without Fabry Perot effects diminishing performance.

A further aspect of the present invention is to provides a fiber coupled GRIN Lens (Graded Index Lens) assembly with a optical coating on the fiber coupling side of the lens specifically selected to closely match the index of refraction of the resin/glue/epoxy used to fix the fiber intimately coupled perpendicularly to the rear of the GRIN lens and to match the refractive index of the glass fiber itself.

An additional aspect of the present invention is to provide a fiber coupled GRIN Lens (Graded Index Lens) assembly with a optical coating on the front side/transmission side of the GRIN lens selected to minimize light reflections at the air glass interface and the forward transmission efficiency plus a optical coating on the rear fiber coupling side of the lens specifically selected to closely match the index of refraction of the resin/glue/epoxy used to fix the fiber intimately coupled perpendicularly to the rear of the GRIN lens and to match the refractive index of the glass fiber itself to minimize reflected light and power and maximize forward light transmission.

A further aspect of the present invention is to provide a fiber coupled GRIN Lens (Graded Index Lens) assembly with a optical coating on the front side/transmission side of the GRIN lens selected to minimize light reflections at the air glass interface and maximize the forward transmission efficiency, plus a optical coating on the rear fiber coupling side of the lens specifically selected to closely match the index of refraction of the resin/glue/epoxy with a thickness of between 3 um and 30 um used to fix the fibers perpendicular end-face proximate to the rear of the GRIN lens after critical alignment and to match the refractive index of the glass fiber itself (Refractive Index 1.47), minimizing the reflected light and power and maximize forward light transmission of the complete fiber coupled GRIN lens assembly.

In order to achieve these aspects and others, the present invention provides an antireflective (AR) coating on a back side of the GRIN lens with a specific coating performance to match the index of refraction of fiber glass, such as 1.47, and then to select an index matching resin to join the components with the same index of refraction as a rear AR coated lens and fiber in the ferrule, such as 1.47, thus achieving virtually lossless cavity, where n₁, n₂ and n_{g} are all the same, so RL is almost infinite and no Fabry Perot effects are observed.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed invention and specific embodiments as a basis for designing or modifying other structures for carrying out the same purposes of the present invention, and that such other structures do not depart from the spirit and scope of the invention in its broadest form.

### BRIEF DESCRIPTION OF THE DRAWINGS

FIG. 1a is a perspective view of a fiber pigtailed collimator configured in accordance with a first embodiment of the present invention;

FIG. 1b is a partially exploded view of the collimator shown in FIG. 1b wherein a resin is shown located between a rear of a gradient index lens and a front of a glass capillary ferrule;

FIG. 1c is a further exploded view of the collimator shown in FIGS. 1a and 1b;

FIG. 2a is perspective view of the collimator shown in FIG. 1a from a different angle;

FIG. 2b is a partially exploded view of the collimator shown in FIG. 1b from a different angle;

FIG. 2c is a further exploded view of the collimator shown in FIG. 1c from a different angle;

FIG. 3a is an end view of the collimator shown in and taken along ling 3a-3a of FIG. 1a;

FIG. 3b is a cross-sectional view of the collimator shown in FIG. 1a;

FIG. 3c is an enlarged view of the circled section “B” shown in the cross-sectional view of FIG. 3b;

FIG. 4a is a perspective view of a collimator configured in accordance with a second embodiment of the present invention;

FIG. 4b is a partially exploded view of the collimator shown in FIG. 4b wherein a resin is shown located between a rear of a gradient index lens and a front of a glass capillary ferrule;

FIG. 4c is a further exploded view of the collimator shown in FIGS. 4a and 4b;

FIG. 5a is perspective view of the collimator shown in FIG. 4a from a different angle;

FIG. 5b is a partially exploded view of the collimator shown in FIG. 4b from a different angle;

FIG. 5c is a further exploded view of the collimator shown in FIG. 4c from a different angle;

FIG. 6a is an end view of the collimator shown in and taken along ling 6a-6a of FIG. 4a;

FIG. 6b is a cross-sectional view of the collimator shown in FIG. 4a;

FIG. 6c is an enlarged view of the circled section “C” shown in the cross-sectional view of FIG. 6b;

FIG. 7a illustrates a conventional spherical lens;

FIG. 7b illustrates a conventional GRIN lens;

FIG. 8a illustrates a typical PC collimator design;

FIG. 8b illustrates a side view of a typical PC collimator design; and

FIG. 9 is a photo of a typical PC collimator.

### DETAILED DESCRIPTION OF THE PREFERRED EMBODIMENT

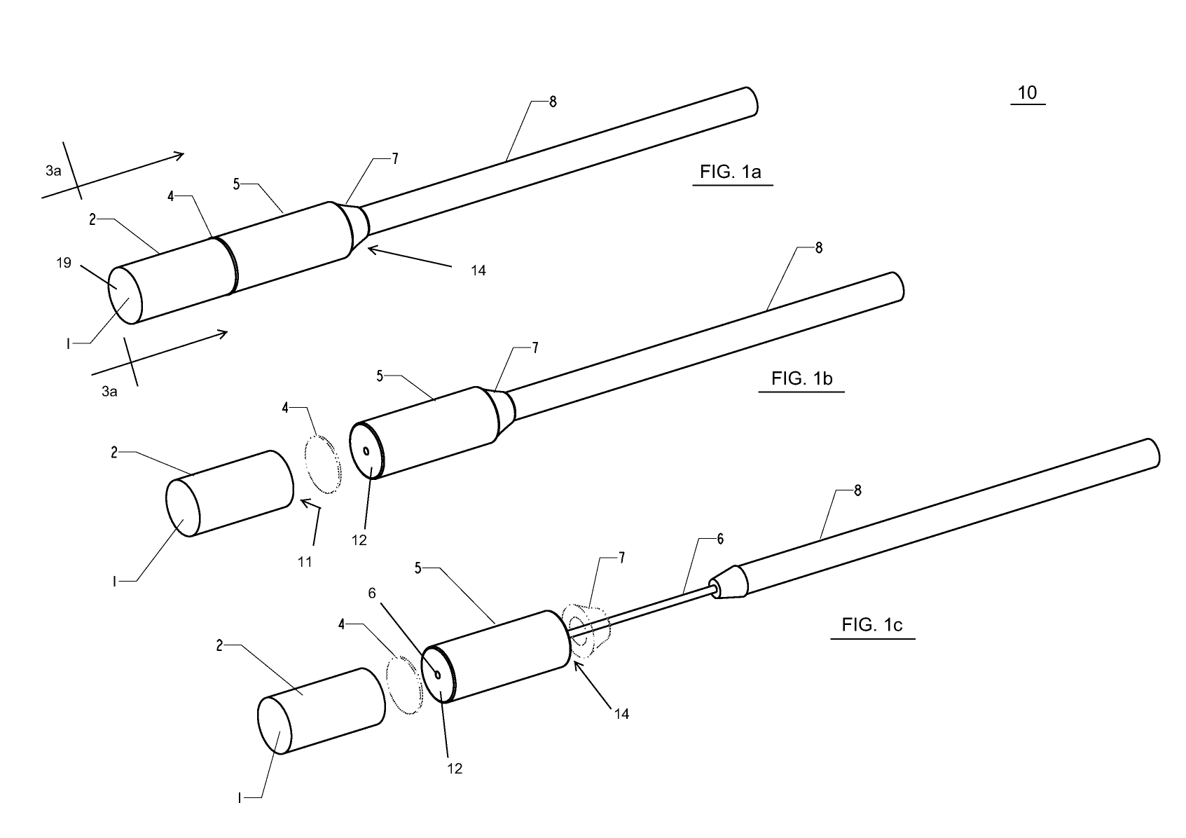

Referring now to the drawings, FIG. 1a illustrates a perspective view of a collimator 10 configured in accordance with a first embodiment of the present invention. FIG. 1b is a partially exploded view of the collimator 10 shown in FIG. 1a, and FIG. 1c is a further exploded view of the collimator shown in FIGS. 1a and 1b. The collimator 10 includes a graded index lens (GRIN lens) 2 having an anti-reflective coating 1 on the front end 19 and on the rear end 11 connected to a front end 12 of a glass capillary ferrule 5, which is preferably constructed of borosilicate glass. A fiber optic 6 is contained within a fiber coating 8, which is preferably constructed of Hytrel or Acrylate other primary and/or secondary coating. The fiber optic 8 extends from within the fiber coating 6 and into and through the rear 14 of the glass capillary ferrule 5. The fiber optic 6 extends through the glass capillary ferrule 5 to the front surface 12 of the glass capillary ferrule 5. A glue 7 secures the fiber coating 8 to the rear 14 of the glass capillary ferrule 5. The glue 7 preferably is an epoxy resin or ultra violet (UV) fixing resin. A glue 16 also is located on an end of the fiber coating 8 to be connected to the rear 14 of the glass capillary ferrule 5.

In accordance with the present invention, an anti-reflective (AR) coating 1 is located on the back 11 of the GRIN lens 2. The AR coating 1 includes an index of refraction to match the index of refraction of the fiber optic 6, which is typically 1.47. Further in accordance with the present invention, a resin 4 is located on and between the rear 11 of the graded index lens (GRIN lens) 2 and the front 12 of the glass capillary ferrule 5. The AR resin 4 on the back 11 of the GRIN lens 2 includes an index of refraction to match the index of refraction of the fiber optic 6, which is typically 1.47. In this manner, a collimator 10 is provided having a virtually lossless light ray transmission, wherein n₁, n₂, and n_{g} (n_{g}=refraction index of GRIN lens) are all equal or very close, so the optical return loss (RL) is almost infinite and no Fabry Perot effects are observed. The use of the matched AR coating on the rear 11 of the GRIN lens 2 overcomes the mismatch of reflective index (RI) between the GRIN lens 2 the optical fiber 6, and the use of a resin with a carefully selected RI to match the AR coating and the fiber 6 also prevents transmitted power from being reflected at any of the material interface surfaces. This also avoids creating a Fabry Perot resonance effect due to interference of light beams reflected back and forth between two parallel surfaces.

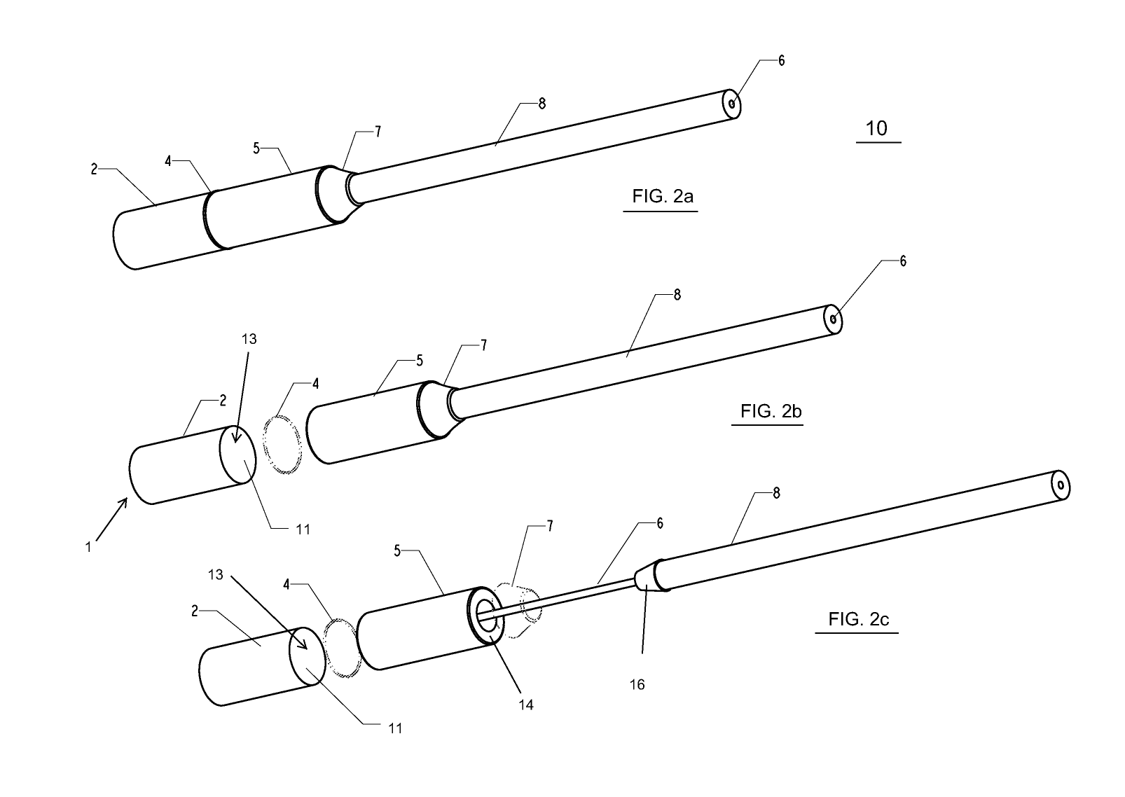

FIG. 2a illustrates a perspective view of a collimator 10 shown in FIGS. 1a-c shown from a different angle. FIG. 2b is a partially exploded view of the collimator 10 shown in FIG. 2a, and FIG. 2c is a further exploded view of the collimator shown in FIGS. 2a and 2b.

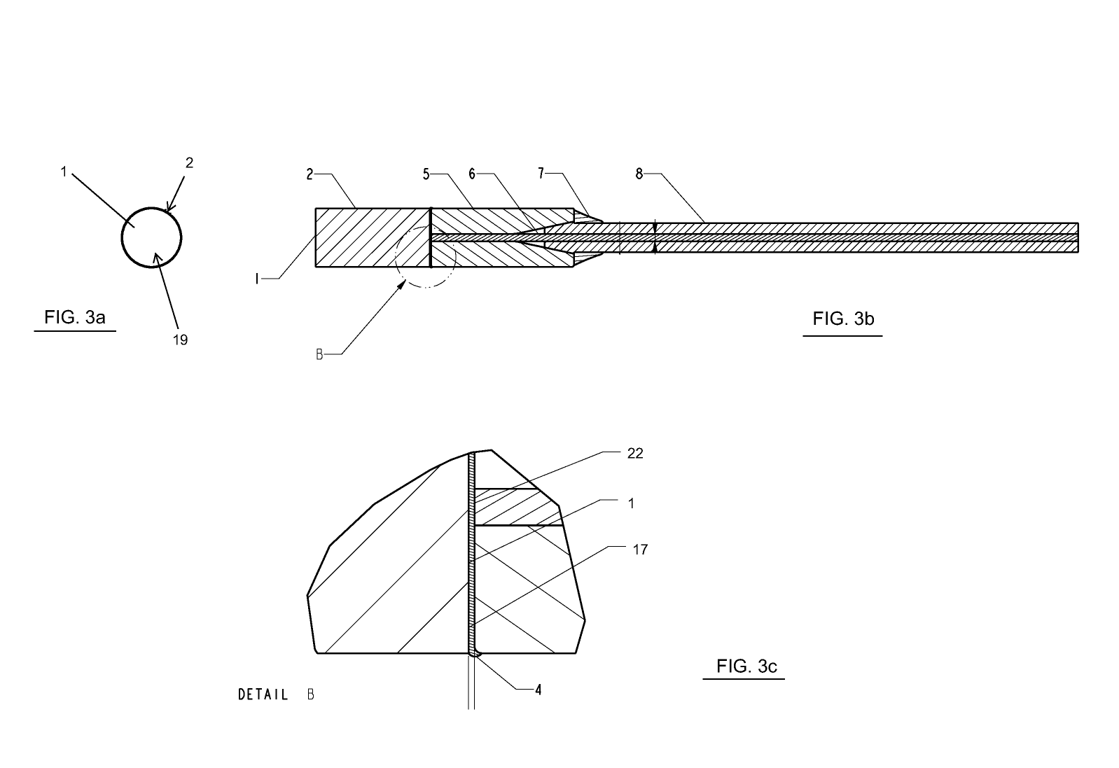

FIG. 3a is an end view of the collimator 10 shown in FIG. 1a. FIG. 3b is a cross-sectional view of the collimator 10 shown in FIG. 1a. FIG. 3c is an enlarged view of the circled sections “B” shown in FIG. 3b. FIG. 3b illustrates the GRIN lens 2, the glass capillary ferrule 5, fiber optic 6, glue 7, and fiber coating 1. FIG. 3c illustrates the resin 4, resin cavity 17, fiber optic end face 22, and glass to resin anti-reflective coating 1.

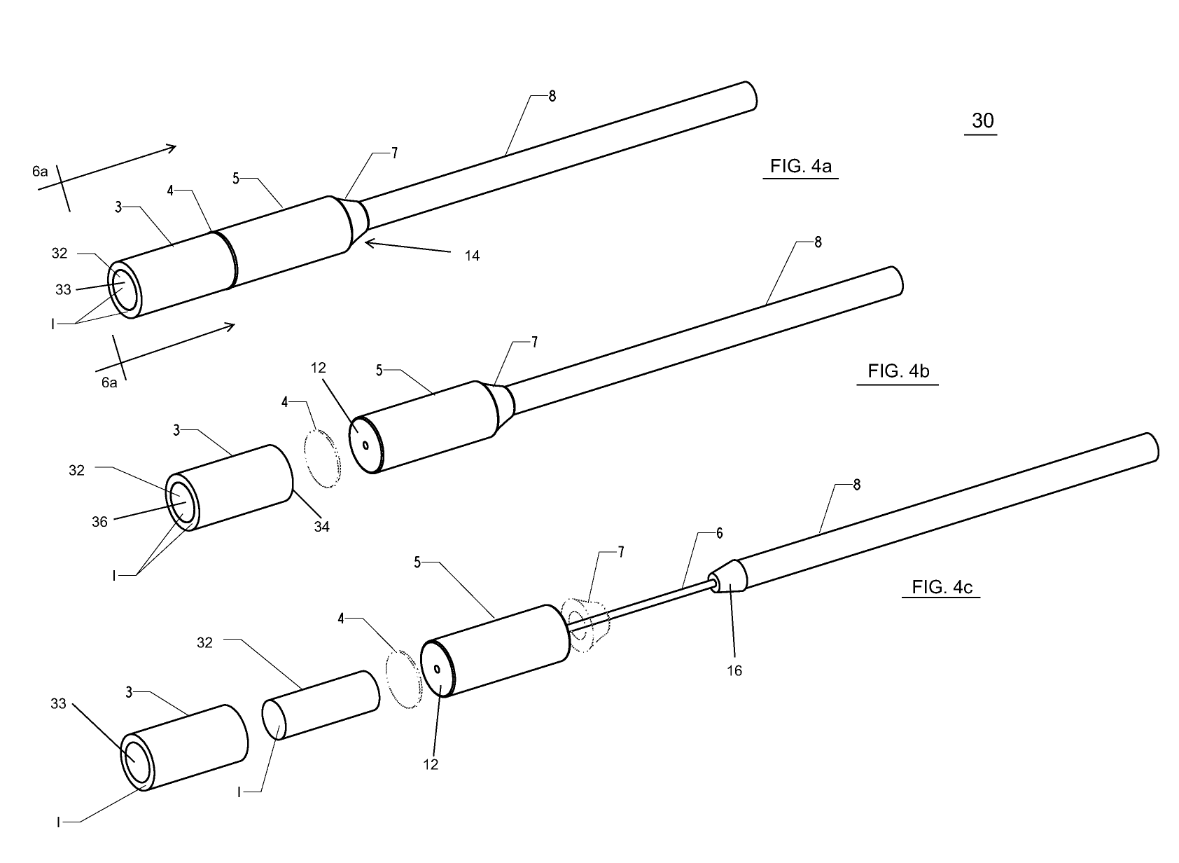

FIG. 4a illustrates a perspective view of a collimator 30 configured in accordance with a second embodiment of the present invention. FIG. 4b is a partially exploded view of the collimator 30 shown in FIG. 4a, and FIG. 4c is a further exploded view of the collimator shown in FIGS. 4a and 4b. The collimator 30 includes a graded index lens (GRIN lens) 32 having a glass to air anti reflective coating 1 on the front end 33 and a rear end 34 connected to a front end 12 of a glass capillary ferrule 5, which is preferably constructed of borosilicate glass. A tube 3, preferably constructed of borosilicate glass, surrounds the GRIN lens 32. The anti-reflective coating 1 also is included on the front 36 of the tube 3.

A fiber optic 6 is contained within a fiber coating 8, which is preferably constructed of Hytrel or Acrylate or other primary and/or secondary coating. The fiber optic 6 extends from within the fiber coating 8 and into and through the rear 14 of the glass capillary ferrule 5. The fiber optic 6 extends through the glass capillary ferrule 5 to the front surface 12 of the glass capillary ferrule 5. A glue 7 secures the fiber coating 8 to the rear 14 of the glass capillary ferrule 5. The glue 7 preferably is an epoxy resin or ultra violet (UV) fixing resin. A glue 16 also is located on an end of the fiber coating 8 to be connected to the rear 14 of the glass capillary ferrule 5.

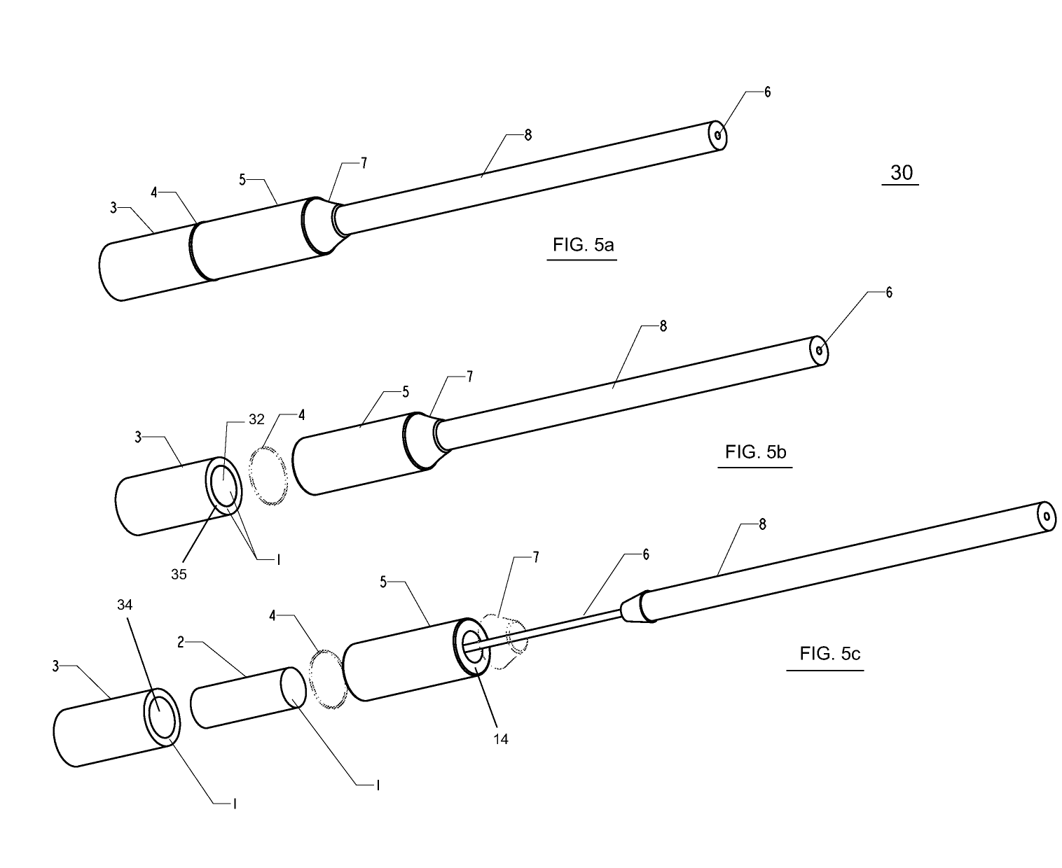

In accordance with the second embodiment of the present invention, an anti-reflective (AR) coating 1 is located on the back 34 of the GRIN lens 32. The AR coating 1 includes an index of refraction to match the index of refraction of the fiber optic 6, which is typically 1.47. Further in accordance with the present invention, a resin 4 is located on and between the rear 34 of the graded index lens (GRIN lens) 32 and the front 12 of the glass capillary ferrule 5. The AR resin 4 on the back 34 of the GRIN lens 32 includes an index of refraction to match the index of refraction of the fiber optic 6, which is typically 1.47. In this manner, a collimator 30 is provided having a virtually lossless light ray transmission, wherein n₁, n₂, and n_{g} (n_{g}=refraction index of GRIN lens) are all equal or very close, so the optical return loss (RL) is almost infinite and no Fabry Perot effects are observed FIG. 5a illustrates a perspective view of a collimator 30 shown in FIGS. 4a-c shown from a different angle. FIG. 5b is a partially exploded view of the collimator 30 shown in FIG. 5a, and FIG. 5c is a further exploded view of the collimator shown in FIGS. 5a and 5b.

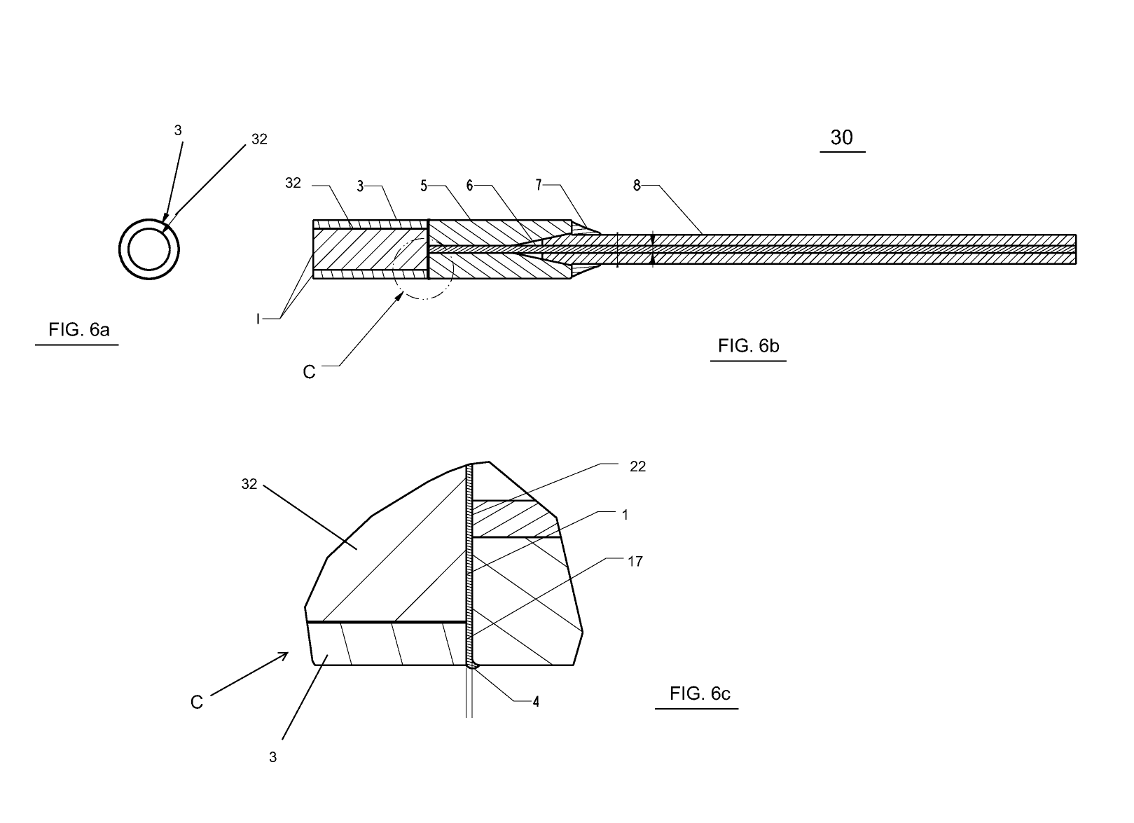

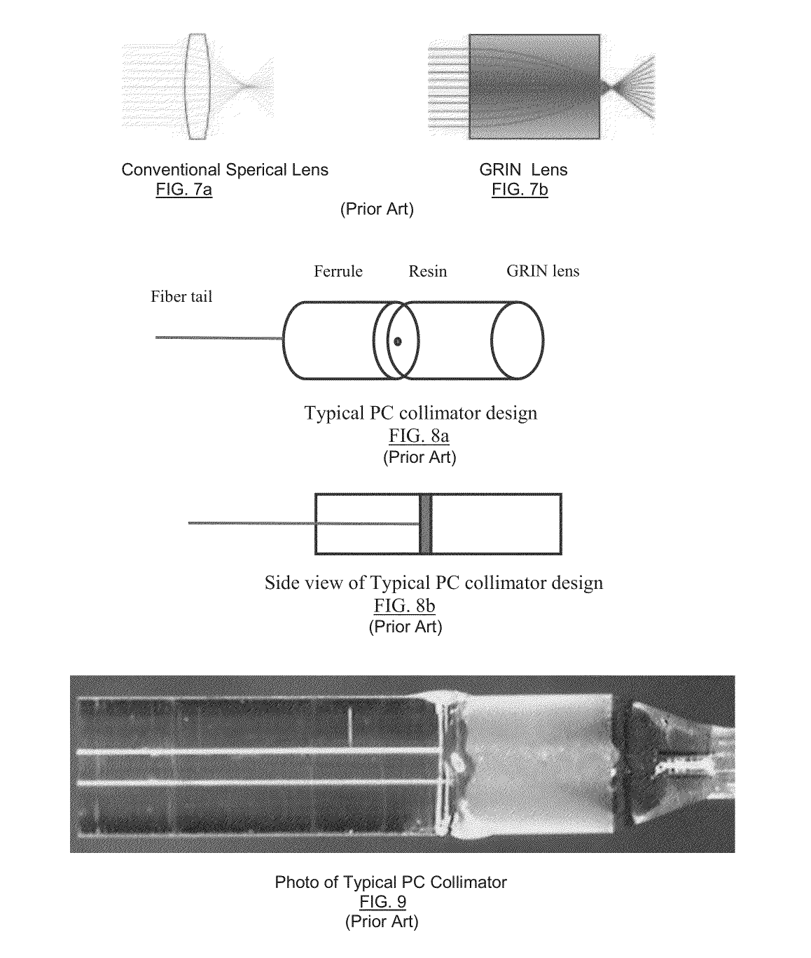

FIG. 6a is an end view of the collimator 30 shown in FIG. 4a. FIG. 6b is a cross-sectional view of the collimator 30 shown in FIG. 4a. FIG. 6c is an enlarged view of the circled sections “C” shown in FIG. 6b. FIG. 6b illustrates the GRIN lens 32, the glass tube 3, the glass capillary ferrule 5, fiber optic 6, glue 7, and fiber coating 8. FIG. 6c illustrates the resin 4, GRIN lens 32, tube 3, fiber optic end face 22, resin cavity 17, and glass to resin anti-reflective coating 1 on GRIN lens 32 and glass tube 3.

While specific embodiments have been shown and described to point out fundamental and novel features of the invention as applied to the preferred embodiments, it will be understood that various omissions and substitutions and changes of the form and details of the invention illustrated and in the operation may be done by those skilled in the art, without departing from the spirit of the invention.

1. A GRIN lens assembly, comprising:
a GRIN lens; and
an AR coating on a back side of the GRIN lens with a specific coating performance to match the index of refraction of an optical fiber; and
one of an index matching resin, glue, and epoxy to join the GRIN lens and the optical fiber with an equal index of refraction as a rear AR coated lens and fiber in the ferrule, where n₁, n₂ and n_{g} are all the same, so RL is almost infinite and no Fabry Perot effects are observed.

2. A fiber pigtailed GRIN (Graded Index Lens) assembly, constructed of a GRIN lens with a AR coating on a back side of the GRIN lens having a specific optical coating performance to match the index of refraction of the glass fiber (typically 1.47), a index matching resin to join and fix the components with the same index of refraction as the rear AR coating on the lens and the glass fiber which is mounted in a ferrule, providing virtually lossless lens, glue/resin, fiber interface cavity, where n1, n2 and ng are all common so the reflected power at the cavity in minimized and the forward transmission power is maximized without Fabry Perot effects diminishing performance.

3. A fiber coupled GRIN Lens (Graded Index Lens) assembly with a optical coating on the front side/transmission side of the GRIN lens selected to minimize light reflections at the air glass interface and maximize the forward transmission efficiency, plus a optical coating on the rear fiber coupling side of the lens specifically selected to closely match the index of refraction of one of a resin and glue and epoxy with a thickness of between 3 um and 30 um used to fix the fibers perpendicular end-face proximate to the rear of the GRIN lens and to match the refractive index of the glass fiber itself (Refractive Index 1.47), minimizing the reflected light and power and maximize forward light transmission of the complete fiber coupled GRIN lens assembly.
